(19) United States
(12) Patent Application Publication
(10) Pub. No.: US 2016/0063422 A1
(43) Pub. Date: Mar. 3, 2016

(54) BUSINESS PROCESS MODEL SYNCHRONIZATION

(71) Applicant: International Business Machines Corporation, Armonk, NY (US)

(72) Inventors: Feng Chen, Beijing (CN); Changrui Ren, Beijing (CN); Ajay Satsangi, Charlotte, NC (US); Qinhua Wang, Beijing (CN)

(21) Appl. No.: 14/470,092

(22) Filed: Aug. 27, 2014

(51) Int. Cl. G06Q 10/06

(52) U.S. Cl. CPC G06Q 10/06316

(57) ABSTRACT

Methods and apparatuses for packaging a business process model is provided. A processor determines one or more differences between a first business process model and one or more templates. A processor determines one or more paths of workflow for the first business process model. A processor generates a first generated model, wherein the generated model includes, at least in part, the determined one or more differences and the determined one or more paths.

### BACKGROUND OF THE INVENTION

The present invention relates generally to the field of business process modeling, and more particularly to the synchronization of a business process model.

Business process modeling is the technique of representing the steps that a business performs to accomplish a goal. A business process includes a collection of activities or tasks that produce a specific service or product in line with the goal. Business processes comprise a set of sequential sub-processes or tasks performed to achieve a given goal. Each process has one or more inputs and outputs. The inputs and outputs of each process connect other business processes, other organizational units, or internal or external stakeholders. The relationship of the various processes that serve as inputs or outputs create a workflow. The workflow details how a business handles specific projects to achieve certain goals. As a business becomes larger and more complex, the workflow generated to achieve the business's goal also increases in complexity. Furthermore, businesses have various business process models for various locations or departments within the business. As such, the business must make sure that those models employed by the locations or departments are aligned with the businesses goal as a whole.

### SUMMARY

Embodiments of the present invention provide a method, system, and program product to package a business process model. A processor determines one or more differences between a first business process model and one or more templates. A processor determines one or more paths of workflow for the first business process model. A processor generates a first generated model, wherein the generated model includes, at least in part, the determined one or more differences and the determined one or more paths.

### BRIEF DESCRIPTION OF THE SEVERAL VIEWS OF THE DRAWINGS

FIG. 1 is a functional block diagram illustrating a business process modeling environment, in accordance with an exemplary embodiment of the present invention.

FIG. 2 illustrates operational processes of synchronizing a business process model, on a computing device within the environment of FIG. 1, in accordance with an exemplary embodiment of the present invention.

FIG. 3A illustrates a set of example business process model templates, in accordance with an exemplary embodiment of the present invention.

FIG. 3B illustrates an example business process model, in accordance with an exemplary embodiment of the present invention.

FIG. 3C illustrates an example business process model, in accordance with an exemplary embodiment of the present invention.

FIG. 4 illustrates operational processes of packaging a business process model, on a computing device within the environment of FIG. 1, in accordance with an exemplary embodiment of the present invention.

FIG. 5 depicts a block diagram of components of the computing device executing the operational processes of FIGS. 2 and 4, in accordance with an exemplary embodiment of the present invention.

### DETAILED DESCRIPTION

While known solutions to synchronizing tasks of business process models are known, they often send each task of business process model in its entirety for synchronization. This includes information that is the same for similar tasks. Embodiments of the present invention recognize that by creating templates describing predetermined arrangements of tasks, a base model is selected and synchronization achieved by communicating a template and differences between the template and the current model that is to be synchronized. By communicating the difference between a model and a template, the amount of information transmitted while synchronizing is reduced. Furthermore, while solutions to communicating a workflow of the business process model are known, typically the tasks and then connections of inputs and outputs are synchronized. Embodiments of the present invention also recognize that a workflow of the business process model is compressed by enumerating the tasks and generating a relationship matrix describing the workflow among the enumerated tasks. By communicating the relationship matrix of a model versus the entire workflow of a model, the amount of information transmitted while synchronizing is reduced.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, systems, and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

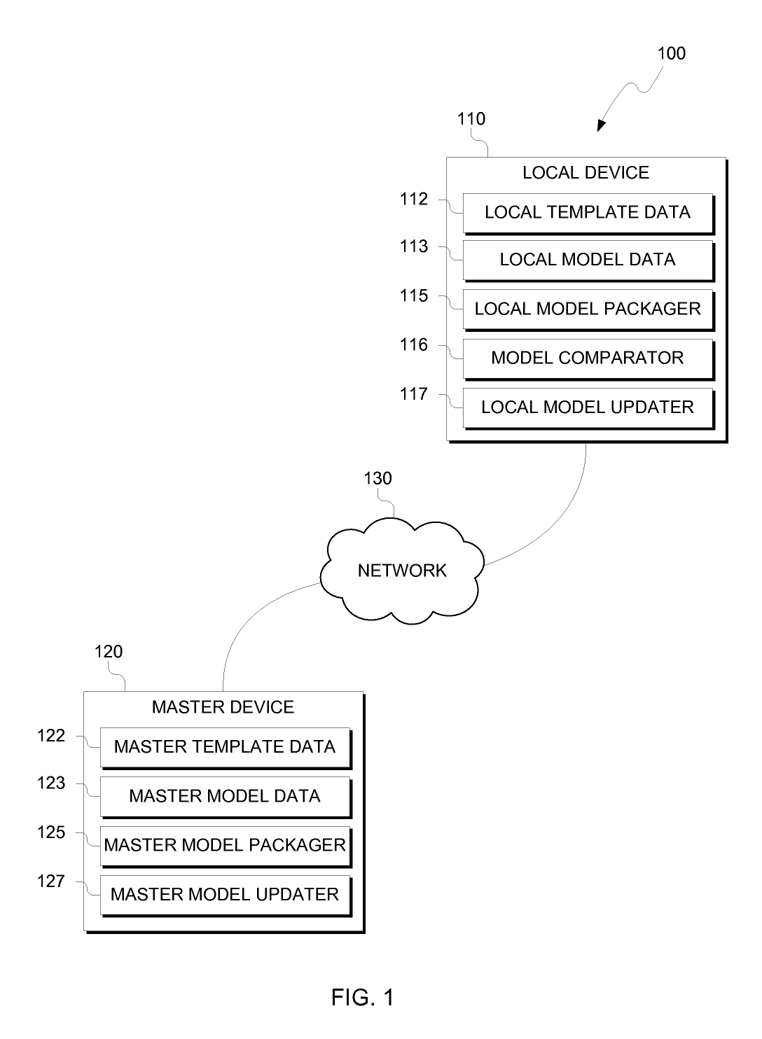

The present invention will now be described in detail with reference to the Figures. FIG. 1 is a functional block diagram illustrating a business process modeling environment, generally designated 100, in accordance with an exemplary embodiment of the present invention. The business process modeling environment 100 includes local device 110 and master device 120 connected over network 130. Local device 110 includes local template data 112, local model data 113, local model packager 115, model comparator 116, and local model updater 117. Master device 120 includes master template data 122, master model data 123, master model packager 125 and master model updater 127.

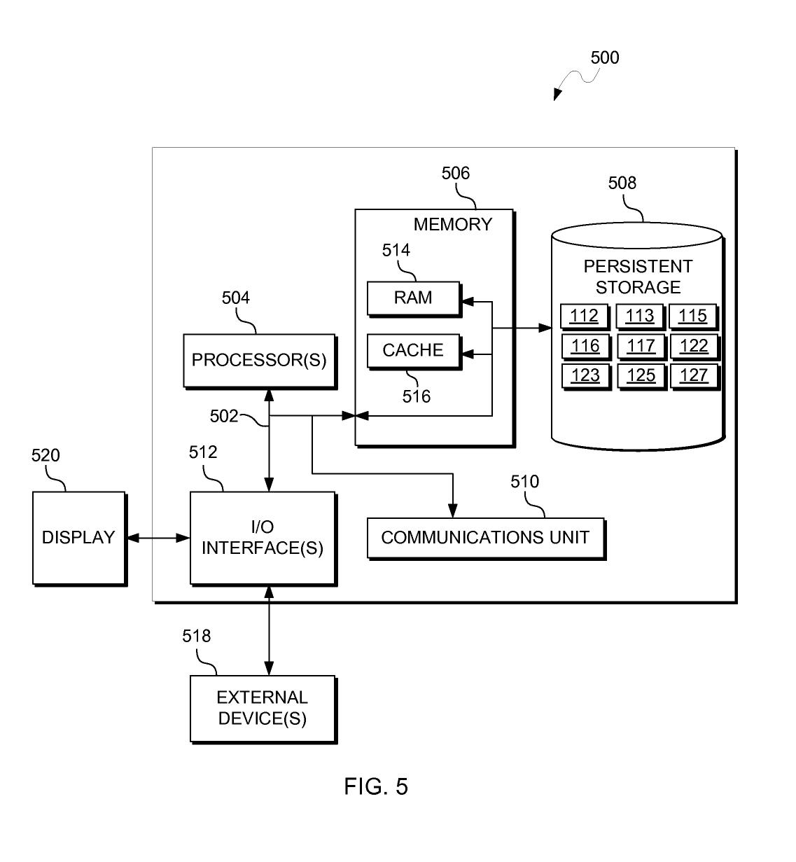

In various embodiments of the present invention, local device 110 and master device 120 are, respectively, computing devices that can be a standalone device, a server, a laptop computer, a tablet computer, a netbook computer, a personal computer (PC), or a desktop computer. In another embodiment, local device 110 and master device 120 each, respectively, represent a computing system utilizing clustered computers and components to act as a single pool of seamless resources. In general, local device 110 and master device 120 can, respectively, be any computing device or a combination of devices with access to local template data 112, local model data 113, master template data 122 and master model data 123 and is capable of executing local model packager 115, model comparator 116, local model updater 117, master model packager 125 and master model updater 127. In an embodiment, local device 110 and master device 120 include, respectively, internal and external hardware components, as depicted and described in further detail with respect to FIG. 5.

In some embodiment, local template data 112, local model data 113, local model packager 115, model comparator 116, and local model updater 117 are stored on local device 110. Master template data 122, master model data 123, master model packager 125 and master model updater 127 are stored on master device 120. However, in other embodiments, local one or more of template data 112, local model data 113, local model packager 115, model comparator 116, local model updater 117, master template data 122, master model data 123, master model packager 125 and master model updater 127 are stored externally and accessed through a communication network, such as network 130. In one embodiment, network 130 is, for example, a local area network (LAN), a wide area network (WAN) such as the Internet, or a combination of the two, and includes one or more of wired, wireless, fiber optic or any other connection known in the art. In general, network 130 is any combination of connections and protocols that will support communications between local device 110 and master device 120, in accordance with a desired embodiment of the present invention.

In certain embodiments, business process modeling environment 100 includes local device 110 and master device 120. Local device 110 and master device 120 store business process models describing projects, processes or tasks that a business or department of a business performs. Local device 110 stores business process models describing particular business processes relevant to the location or department that local device 110 operates on behalf of. Local model data 113 stores business process models used by local device 110. In some embodiments, multiple local devices (not shown) are connected to network 130, each storing business process models relevant to the location or department the device services. For example local device 110 is provided for a repair facility in one location and another local device 110 is provided for a call center in a second different location. Embodiments of the invention recognize that multiple devices similar to local device 110 stores different business process models in each devices respective instance of local model data 113.

In this embodiment, master device 120 operates as a repository of business process models describing various processes a business or department of a business performs as a whole. Master model data 123 stores business process models similar to the business process models stored in local model data 113 on local device 110. Master model data 123 stores other business process models not stored on local device 110. Local model updater 117 and master model updater 127 synchronize, respectively, differences between master model data 123 and local model data 113. Synchronization is discussed in more detail below with regards to model packagers 115 and 125, model comparator 116 and local model updater 117.

Business process models describe the operations a particular business or department of a business performs. For example, a business process model describes the operations of a manufacturing facility of a business. The business process model stores information regarding the processes the manufacturing facility utilizes to produce a widget. For example, processes include sourcing raw materials, prepping the raw materials, molding the raw materials into parts and assembling the widget. As another example, the business process model stores business processes for a marketing division of a territory. For example, the business processes include analyzing a market, creating forecasts, determining advertising campaigns, budgeting advertising plans, monitoring sales and determining an advertising plan's effectiveness.

In some embodiments, business process models describe any number of business processes and a flow of operation among the business processes. Business process models store project data. Project data describes an overall function or operation that a business performs. For example, a project describes manufacturing a product (e.g., this year's car model) or starting a new business venture (e.g., introducing a product to a new market). Business process models store process data. Process data details the processes needed for a project. For example in a manufacturing project, an example process is assembling the product. In general, processes define overall steps of a project. Business process models store task data. Task data describes the tasks needed to be performed to conduct a particular process. For example, a final assembly process includes the tasks to be performed to assemble the final product (e.g., bolt part A to Part B, weld Part C to part D, etc.). In other embodiments, a defined project or process is not required for a task. A process does not require defined tasks for the process. A project does not require component processes.

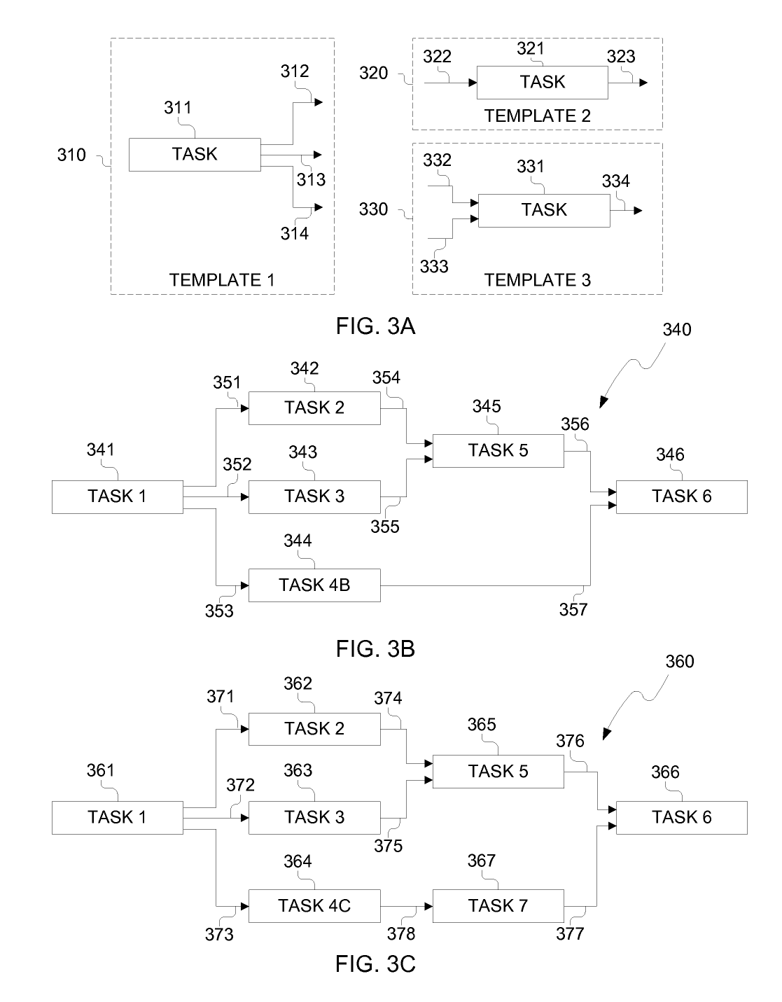

Business process models stores descriptions of projects, processes or tasks of a business model. In some embodiments, the descriptions are general descriptions (e.g., fasten with a screw) or specific descriptions (i.e. fasten with a 4-40 UNC 2A screw). Business process models store the connections between the respective projects, processes or tasks as paths. Paths indicate the relationship a project, process or task has with other projects, processes or tasks in a business process model. In some embodiments, a business model has multiple relationships from one project, process or task to another project, process or task. FIG. 3B illustrates an example business process model comprising projects, processes or tasks (e.g. 341, 342, etc.) and relationships (e.g. 351, 352, etc.). Business process models define relationships between the projects, processes or tasks as a workflow, where one project, process or task is to be completed prior to another project, process or task. The workflow is indicated by the direction of the arrow of the relationship, where the project, process or task with the arrow leading into is to be completed after the project, process or task the arrow is leading out of is completed.

In certain embodiments, local device 110 and master device 120 store local template data 112 and master template data 122. Local template data 112 and master template data 122 store business process models which represent universal or generic business process models that are used to represent business process models stored in local model data 113 or master model data 123, respectively. For example, local device 110 stores a business process model representing a manufacturing process for a specific facility in local model data 113. Local template data 112 stores a similar business process model which represents a business process model for manufacturing that covers multiple facilities. A specific task implemented at the facility states that a specific part be used from a particular supplier (e.g., fasten Part A from supplier B). Local template data 112 stores a generic description of the task where the action (e.g. fasten a part) is stored, but the specifics details of the task (e.g. part number and supplier) are not stored in local template data 112.

In certain embodiments, local template data 112 and master template data 122 share similar descriptions of projects, processes and tasks. Local template data 112 and master template data 122 store generic descriptions of projects, processes and tasks that are used in local model data 113 and master model data 123 to represent business process models. Local template data 112 and master template data 122 store models of broader descriptions of projects, processes and tasks. Local template data 112 and master template data 122 provide a basis to compare the business process models stored in local model data 113 and master model data 123. Model comparator 116 compares local model data 113 and master model data 123 to local template data 112 and master template data 122, respectively, to determine differences between the templates and the actual business process model that are being simulated. A difference between a template and a model provides a smaller data set to use when describing the model data as a whole, due to the similarities between the template and the model being redundant information. The determination of the differences and comparisons are discussed below in further detail with regards to local model packager 115 and model comparator 116.

In other embodiments, local template data 112 and master template data 122 store different template data. Local template data 112 stores only templates describing business process models applicable to users of local device 110. The business process models represent models that local device stores in local model data 113. Conversely, master template data 122 stores a larger selection of templates encompassing any business process models that master device 120 synchronizes with other devices (not shown) of network 130. For example, master template data 122 stores template data for a manufacturing process and a customer support process, where local device 110 stores a manufacturing process in local model data 113 and another device of network 130 stores a model for the customer support process.

In some embodiments, local template data 112 stores override information as part of local template data 112 in addition to the business process model templates. Based on the override information, local template data 112 indicates that determined differences between local template data 112 and local model data 113 should not be synchronized. If a particular location has a specialized process or task that is performed, then local template data 112 stores an override indication regarding the process or task that is not to be performed or to be performed in a different manner. If an override indication is given for a process or task description stored in local template data 112, then differences between local model data 113 and master model data 123 are not be synchronized.

In certain embodiments, local model packager 115 generates a simplified model of local model data 113. The simplified model includes a difference model representing differences in descriptions between local model data 113 and local template model data 112. The simplified model also includes a relationship matrix describing the paths of the projects, processes and task of local model data 113. Local model packager 115 determines differences in the descriptions between local model data 113 and local template model data 112. For example, if the descriptions for a task stored in local model data 113 are different from the description of the task in local template data 112, then local model packager 115 will include the new description in the simplified model, indicating the task the difference is found. Local model packager 115 determines any differences in the descriptions between projects, processes and task stored in local model data 113 to the templates stored in local template data 112. The differences in descriptions for a given project, process or task are gathered and comprise the simplified model.

Master model packager 125 generates a simplified model of master model data 123. Master model packager performs a similar function as the local model packager 115 discussed above. Master model packager 125 generates a difference model representing any differences in the descriptions between projects, processes and task stored in master model data 123 to the templates stored in master template data 122. Master model packager 125 generates the difference model including master local data 123 and master template data 122 for projects, processes or tasks representing business process models stored in local model data 113. Master model packager 125 generates a difference model for business process models stored in order to synchronize the models stored in local model data 113 with the applicable models stored in master model data 123.

In certain embodiments, local model packager 115 generates a relationship matrix describing the paths of local model data 113. The relationship matrix is a binary matrix indicating a connection from one project, process or task to another project, process or task. Local model packager 115 determines the number of projects, processes or tasks that are stored in a business process model. Local model packager 115 creates a square matrix that is equal to the number of tasks (e.g. there are n tasks and the resulting matrix is n-by-n). Local model packager 115 designates a row and column for each project, process or task stored in local model data 113. The relationship value of the matrix for a given coordinate is a “1” or true when a connection exists for a task to another task. If a connection does not exist, the relationship value is equal to “0” or false. The connection indicates a forward connection from one project, process or task to another project, process or task. A forward connection indicates a dependency that a previous (or parent) project, process or task is to be completed prior to a following (or child) project, process or task is to begin. In some embodiments, the relationship indicates the reverse (e.g. that a child project, process or task depends on a parent project, process or task). In some embodiments, the rows of the matrix indicate parent projects, processes or tasks. The columns of the relationship matrix indicate child projects, processes or tasks. In other embodiments, the relationship is reversed, where columns indicate parent project, process or task and rows indicate child project, process or task. A more detailed discussion of the relationship matrix and its determination is found below in FIG. 3.

Master model packager 125 generates a relationship matrix based on the connections of master model data 123 in a similar manner as discussed above with regards to local model packager 115. Master model packager 125 determines a relationship matrix for projects, processes or tasks to be synchronized for local model data 113 stored on local device 110. In certain embodiments, master model packager 125 sends both the difference model and relationship matrix to model comparator 116 of local device 110. In other embodiments, master device 120 receives the generated differences model and relationship matrix of local model packager 115 from local device 120.

In certain embodiments, model comparator 116 receives the difference models and relationship matrices from local model packager 115 and master model packager 125. Based on the device that Model comparator 116 determines changes in descriptions between the difference model generated by local model packager 115 and the difference model generated by master model packager 125. The changes in descriptions of the local difference model in view of the master difference model are sent to master model updater 127. The changes in descriptions of the maser difference model in view of the local difference model are sent to local model updater 117.

Model comparator 116 determines changes in relationships between the difference model generated by local model packager 115 and the difference model generated by master model packager 125. A change in relationships of projects, processes or tasks are indicated by different values in the local and master relationship matrix. Any changes in the relationship matrix of the local relationship matrix in view of the master relationship matrix are sent to master model updater 127. Any changes in the relationship matrix of the local relationship matrix in view of the master relationship matrix are sent to local model updater 117.

Local model updater 117 merges the changes received from model comparator 116 with local model data 113. With changes in the descriptions of projects, processes or tasks, local model updater 117 changes the description of project, process or task that is indicated in local model data 113. In some embodiments, a project, process or task stored in local model data 113 is locked and will not be updated with the indicated changes. Similarly, master model updater 127 merges the changes received from model comparator 116 with master model data 123. With changes in the descriptions of projects, processes or tasks, master model updater 127 changes the description of project, process or task that is indicated in master model data 123. In some embodiments, a project, process or task stored in master model data 123 is locked and will not be updated with the indicated changes.

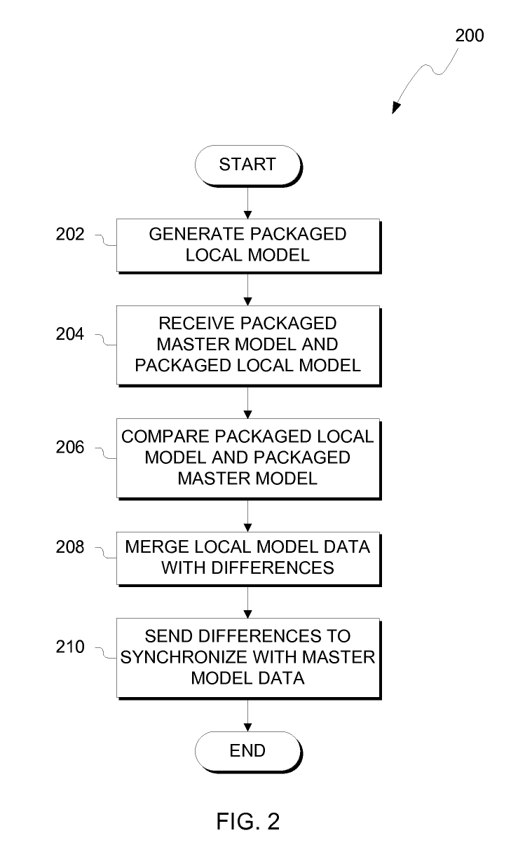

FIG. 2 is a flowchart illustrating operational processes, generally designated 200, of synchronizing a business process model, on a computing device within the environment of FIG. 1, in accordance with an exemplary embodiment of the present invention.

In process 202, local model packager 115 generates a packaged local model for one or more business process models based on local model data 113 and local template data 112. Local model packager 115 retrieves one or more business process models stored in local model data 113. In some embodiments, local model packager 115 matches one or more business process model templates, stored in local template data 112, used to represent the one or more business process models stored in local model data 113. In other embodiments, local model data 113 stores an indication of one or more templates stored in local template data 112 used to represent the one or more business process models. Local model packager 115 compares components of the one or more business process models stored in local model data 113 to the templates stored in local template data 112. Local model packager 115 generates a packaged local model including any differences between local model data 113 and local template data 112. For example, a template for a loan processing business process includes a description for a task (e.g., “Approve Loan Task”) which includes a comparison of a credit score to a user's credit score, however a threshold is not defined (e.g., approve if credit score is above???). Local model data 113 includes a task based on the template also including a specific threshold (e.g., approve if credit score is above 600). Local model packager 115 will generate a packaged local model which includes the type of template used (e.g., “Approve Loan Task”) in addition to the difference between the template and the business process model stored in local model data 113 (e.g. 600). As another example, a template includes no task description; however, the template has a certain number of input and output paths. Local model data 113 includes a task based of the template including a task description and the input and output tasks that are part of the business process model. Local model packager 115 generates a packaged local model, which includes the differences from the template. In this example, the packaged local model includes the task description stored in local model data 113 and the input and output tasks for the tasks as represented in the business process model stored in local model data 113.

In process 204, model comparator 116 receives a packaged master model and a packaged local model from master device 120 and local device 110, respectively. Master model packager 125 generates a packaged master model in a similar manner to local model packager 115 of local device 110. In some embodiments, master model data 123 stores one or more different business process models to be synchronized with local model data 113. Master model packager 125 retrieves one or more business process models stored in master model data 123. Master model packager 125 compares components of the one or more business process models stored in master model data 123 to the templates stored in master template data 122. Master model packager 125 generates a packaged local model including any differences between master model data 123 and master template data 122.

In process 206, model comparator 116 compares the packaged local model to the packaged master model. Model comparator 116 determines if any differences are present, and based on the determination of a difference between the packaged models, generates an indication of the difference. In some embodiments, model comparator 116 indicates differences with a preference to master model data 123. For example, if an addition is made to master model data 123 that is not present in local model data 113, then model comparator 116 will indicate that the difference should be merged with local model data 113. In other embodiments, local model data 113 takes preference over master model data 123. In other embodiments, local model data 113 includes a lock to a particular component of the business process model. In such embodiments, model comparator 116 will not determine differences between the local packaged model and the master packaged model.

In process 208, local model updater 117 merges the differences indicated by model comparator 116 with local model data 113. Model comparator 116 sends the indications of differences between the local packaged model and the master packaged model to local model updater 117. In some embodiments, model comparator 116 sends indications of the differences necessary to synchronize local model data 113 with master model data 123. For example, if a task description is to be changed in local model data 113, then model comparator 116 sends the indication to local model updater 117. If a task is to be removed from master model data 123, then model comparator 116 does not send the indication to local model updater 117. Local model updater 117 updates local model data 113 based on the differences indicated by model comparator 116.

In process 210, model comparator 116 sends the indications of differences determined above (process 206) to master model updater 127. In some embodiments, model comparator 116 sends indications of the differences necessary to synchronize master model data 123 with local model data 113. For example, if a task has a new output path present in local model data 113, then model comparator 116 sends the indication to master model updater 127. Master model updater 127 updates master model data 123 based on the differences indicated by model comparator 116.

FIG. 3A illustrates a set of example business process model templates, in accordance with an exemplary embodiment of the present invention. FIGS. 3B and 3C illustrates an example business process models, in accordance with an exemplary embodiment of the present invention.

Referring to FIG. 3A, example templates 310, 320 and 330 are illustrated. A template includes at least one task and at least one path. For example, template 310 includes one task (task 311) and three output paths (path 312, 313 and 314). Template 320 includes a one task (task 321), an input path (path 322) and an output path (path 323). Template 330 includes a task (task 331), two input paths (path 332 and 333) and one output path (path 334). In certain embodiments, local template data 112, master template data 122, local model data 113 and master model data 123 are represented by a modeling language. For example, templates and business process models are modeled using extensible markup language, or XML. The XML model defines nodes (to represent projects, processes or tasks) and input and output pins (to represent the path of the business model). Table 1 below is an example XML code for a node:

```
TABLE 1
<nodeContents
  xsi:type=“com.btools.bom.model.processes.activities:StructuredActivity
  Node” xmi:id=“BLM-a7ba3d574d62ebbe3068b016d5de57f5”
  uid=“BLM-a7ba3d574d62ebbe3068b016d5de57f5”
  name=“task1” aspect=“TASK”>
    <inputControlPin
      xmi:id=“BLM-4f81e78c79182809e1a0327bbc91c624”
      uid=“BLM-4f81e78c79182809e1a0327bbc91c624” name=“input”
      incoming=“BLM-28390b21380699c127175741816c5ad6”/>
    <inputControlPin
      xmi:id=“BLM-2d4029ed9dd85ffa6f0e22b89419f335”
      uid=“BLM-2d4029ed9dd85ffa6f0e22b89419f335” name=“input
      condition”
      incoming=“BLM-9fe6b4cf9da8d745f092a5f0ffb12687”/>
    <outputPinSet xmi:id=“BLM-da3860ee591f0bdd768d50ed5dfda622”
      uid=“BLM-da3860ee591f0bdd768d50ed5dfda622” name=“output”
      inputPinSet=“BLM-9aed1f03fee18ee903b76071e089d626”/>
    <inputPinSet xmi:id=“BLM-9aed1f03fee18ee903b76071e089d626”
      uid=“BLM-9aed1f03fee18ee903b76071e089d626” name=“output
      condition” outputPinSet=“BLM-
      da3860ee591f0bdd768d50ed5dfda622” inputControlPin=“BLM-
      4f81e78c79182809e1a0327bbc91c624 BLM-
      2d4029ed9dd85ffa6f0e22b89419f335”/>
</nodeContents>
```

Table 1 above describes a specific task similar to template 330 where a task has two input paths and one output path. If a business process model includes another similar structure (e.g. a task with two input paths and one output path), then a separate portion of the XML model reflects this additional task. Table 2 below is an example XML model for a similar node to Table 1:

```
TABLE 2
<nodeContents
  xsi:type=“com.btools.bom.model.processes.activities:StructuredActivity
  Node” xmi:id=“BLM-03555714320ad875670570475286edac”
  uid=“BLM-03555714320ad875670570475286edac” name=“task2”
  aspect=“TASK”>
    <inputControlPin
      xmi:id=“BLM-bcd641ea7441763d033dcf5015e13ff7”
      uid=“BLM-bcd641ea7441763d033dcf5015e13ff7” name=“input”
      incoming=“BLM-148f05e4244904e45637e655b59ac8bb”/>
    <inputControlPin
      xmi:id=“BLM-39219bf58942b886e96543680c5f6db5”
      uid=“BLM-39219bf58942b886e96543680c5f6db5” name=“input
      condition“ outgoing=“BLM-
      28390b21380699c127175741816c5ad6”/>
    <outputPinSet xmi:id=“BLM-5e1f0827f553680a4069bd394d6e1146”
      uid=“BLM-5e1f0827f553680a4069bd394d6e1146” name=“output”
      inputPinSet=“BLM-bb8542a9d9ac648a0ea3a7e81a591e82”
      outputControlPin=“BLM-39219bf58942b886e96543680c5f6db5”/>
    <inputPinSet xmi:id=“BLM-bb8542a9d9ac648a0ea3a7e81a591e82”
      uid=“BLM-bb8542a9d9ac648a0ea3a7e81a591e82” name=“output
      condition” outputPinSet=“BLM-
      5e1f0827f553680a4069bd394d6e1146” inputControlPin=“BLM-
      bcd641ea7441763d033dcf5015e13ff7”/>
</nodeContents>
```

In certain embodiments, local template data 112 and master template data 122 store the similar portions of the models such that said portions of the model are represented. When generating a packaged model, local model packager 115 and master model packager 125 transmit the differences between the model and the template used to generate the portion of the model. Table 3 below is an example template modeled in XML representing template 330:

```
TABLE 3
<nodeContents
  xsi:type=“com.btools.bom.model.processes.activities:StructuredActivity
  Node” xmi:id=“?” uid=“?” name=“?” aspect=“TASK”>
    <inputControlPin xmi:id=“?” uid=“?” name=“input” incoming=“?”/>
    <inputControlPin xmi:id=“?” uid=“?” name=“input condition”
      incoming=“?”/>
    <outputPinSet xmi:id=“?” uid=“?” name=“output” inputPinSet=“?”/>
    <inputPinSet xmi:id=“?” uid=“?” name=“output condition”
      outputPinSet=“?” inputControlPin=“?”/>
</nodeContents>
```

In the above Table 3, the template includes the portions of the XML model which are similar for both nodes shown in Table 1 and Table 2. The template includes placeholders, denoted by “?”, for the portions of the XML models of Tables 1 and 2 that differ. When generating the packaged model, local model packager 115 and master model packager 125 generate packaged models with the information that differs from the XML models as shown in Tables 1 and 2 with the template shown in Table 3. An example packaged model is shown in Table 4 below:

TABLE 4

“Template 3”
“BLM-a7ba3d574d62ebbe3068b016d5de57f5”
“BLM-a7ba3d574d62ebbe3068b016d5de57f5”
“task1”
“BLM-4f81e78c79182809e1a0327bbc91c624”
“BLM-4f81e78c79182809e1a0327bbc91c624”
“BLM-28390b21380699c127175741816c5ad6”
“BLM-2d4029ed9dd85ffa6f0e22b89419f335”
“BLM-2d4029ed9dd85ffa6f0e22b89419f335”
“BLM-9fe6b4cf9da8d745f092a5f0ffb12687”
“BLM-da3860ee591f0bdd768d50ed5dfda622”
“BLM-da3860ee591f0bdd768d50ed5dfda622”
“BLM-9aed1f03fee18ee903b76071e089d626”
“BLM-9aed1f03fee18ee903b76071e089d626”
“BLM-9aed1f03fee18ee903b76071e089d626”
“BLM-da3860ee591f0bdd768d50ed5dfda622”
“BLM-4f81e78c79182809e1a0327bbc91c624”
“BLM-2d4029ed9dd85ffa6f0e22b89419f335”
“Template 3”
“BLM-03555714320ad875670570475286edac”
“BLM-03555714320ad875670570475286edac”
“task2”
“BLM-bcd641ea7441763d033dcf5015e13ff7”
“BLM-bcd641ea7441763d033dcf5015e13ff7”
“BLM-148f05e4244904e45637e655b59ac8bb”
“BLM-39219bf58942b886e96543680c5f6db5”
“BLM-39219bf58942b886e96543680c5f6db5”
“BLM-28390b21380699c127175741816c5ad6”
“BLM-5e1f0827f553680a4069bd394d6e1146”
“BLM-5e1f0827f553680a4069bd394d6e1146”
“BLM-bb8542a9d9ac648a0ea3a7e81a591e82”
“BLM-39219bf58942b886e96543680c5f6db5”
“BLM-bb8542a9d9ac648a0ea3a7e81a591e82”
“BLM-bb8542a9d9ac648a0ea3a7e81a591e82”
“BLM-5e1f0827f553680a4069bd394d6e1146”
“BLM-bcd641ea7441763d033dcf5015e13ff7”

In the above Table 4, the packaged model includes only the model information where placeholders are present (e.g., task identifiers and descriptions) in addition to an indication as to what template is used (e.g., “Template 3”). Since template 330 is stored both in local template data 112 and master template data 122 in this example, the portion of the model stored in the template (e.g. Table 3) does not need to be transferred when synchronizing model data. By not transmitting the portion of the model stored as a template, the packaged model is comparatively smaller than transmitting the model in its entirety. For example, by transmitting both models (e.g. Tables 1 and 2), a transmission size of 1,983 characters is sent, where Table 1 contains 982 characters and Table 2 contains 1,001 characters. By creating templates, such as template 330, and transmitting the differences (e.g., Table 4) from the template (e.g., Table 3) and the models (Tables 1 and 2), a transmission size of 1,252 characters is sent, resulting in a smaller amount of information required for transmitting the model. As a model becomes more complex and includes more occurrences of a template, the transmission size of a packaged model decreases.

FIG. 3B illustrates an example business process model, 340, including a set of tasks, (i.e., task 341, 342, 343, 344, 345 and 346) and paths indicating the workflow of tasks to complete the process of the business process model (i.e., path 351, 352, 353, 354, 355, 356 and 357). As part of the illustrative example, example business process model 340 is stored in local model data 113. In certain embodiments, local model packager 113 determines a template stored in local template data 112 to match components of example business process model 340. For example, local model packager 115 matches template 310 to task 341 and path 351, 352 and 353 since the component has one task and three output paths. Local model packager 115 matches template 320 to three components of example business process model 340. The first component includes task 342, input path 351 and output path 354. The second component includes task 343, input path 352 and output path 355. The third component includes task 344, input path 353 and output path 357. Local model packager 115 matches template 330 to two components of example business process model 340. The first component includes task 345, input path 354, input path 355 and output path 356. The second component includes task 346, input path 356, input path 357 and a deleted output path. By using a similar template, even though an output path does not exist for the second component matched to template 330, local model packager 115 matches components to templates if a broader template is matched. In this example, since template 330 includes two input paths and one output path, local model packager 115 determines template 330 to be the closest match and generates the differences between the component and the template (e.g. the output path should be removed in addition to the identifiers of the task 346 and input paths 356 and 357).

FIG. 3C illustrates an example business process model, 360, including a set of tasks, (i.e., task 361, 362, 363, 364, 365, 366 and 367) and paths indicating the workflow of tasks to complete the process of the business process model (i.e., path 371, 372, 373, 374, 375, 376, 377 and 378). As part of the illustrative example, example business process model 360 is stored in master model data 123. Master model packager 125 matches templates 310, 320 and 330 to example business process model 360 in a similar manner as local model packager 113 discussed above. However, a new task has been added to example business process model 360, task 367, with input path 378 and output path 377. Master model packager 125 matches template 320 to the added component (e.g. task 367 and path 377 and 378). In addition to the new task 367, the task descriptions for task 364 are different from task 344. Model comparator 116 determines the difference when the placeholder for the tasks descriptions is compared.

In addition to determining difference between a components of business process model and a template, local model packager 116 and master model packager 126 determine a relationship matrix to indicate the workflow of the component tasks for a given business process model. For example, given example business process model 340 is stored in local model data 113, local model packager 115 determines a binary squared matrix with the rows and columns equal to enumerated tasks present in the business process model stored in local model data 113. Local model packager 115 numbers task 341 as “1”, task 342 as “2”, task 343 as “3”, task 344 as “4”, task 345 as “5” and task 346 as “6”. Each element of the matrix indicates a forward workflow from one task to another (e.g., the direction an arrow of a path in the workflow). An example relationship matrix, RM, for example business process model 340 of FIG. 3B is shown below:

$$R M = [ \begin{matrix}0 & 1 & 1 & 1 & 0 & 0 \\ 0 & 0 & 0 & 0 & 1 & 0 \\ 0 & 0 & 0 & 0 & 1 & 0 \\ 0 & 0 & 0 & 0 & 0 & 1 \\ 0 & 0 & 0 & 0 & 0 & 0 \\ 0 & 0 & 0 & 0 & 0 & 0\end{matrix} ]$$

The relationship matrix is a squared matrix of size A×B where, A and B are equal to the number of tasks in a business process model. In the example business process model 340, six tasks are represented; therefore, the matrix is 6×6. A coordinate of the matrix (i.e, (A,B)) is true or a “1” if a forward workflow exists from task A to task B. If a forward workflow is not present between task A and task B, for a given coordinate, then the relationship matrix is false or a “0”. For example, coordinate (1,2) is true due to a forward workflow from task 341 (enumerated “1”) to task 342 (enumerated “2”). Coordinate (4,5) is false due to not having forward workflow from task 344 and task 345. Table 5 below illustrates the matrix in the form of a table with coordinates.

TABLE 5

| | | | | | | | Encoded Values |
|---|---|---|---|---|---|---|---|
| | 1 | 2 | 3 | 4 | 5 | 6 | for Rows |
| 1 | 0 | 1 | 1 | 1 | 0 | 0 | 16 |
| 2 | 0 | 0 | 0 | 0 | 1 | 0 | 02 |
| 3 | 0 | 0 | 0 | 0 | 1 | 0 | 02 |
| 4 | 0 | 0 | 0 | 0 | 0 | 1 | 01 |
| 5 | 0 | 0 | 0 | 0 | 0 | 1 | 01 |
| 6 | 0 | 0 | 0 | 0 | 0 | 0 | 00 |

In certain embodiments, local model packager 115 and global model packager 125 encode the matrix into hexadecimal values of the bit string for each row. For example, the first row of Table 5 indicates workflow from task 341 to all other tasks of example business process model 340. Local model packager 115 generates a bit string equal to “011100”. Local model packager 115 generates a hexadecimal equivalent of the bit string (i.e., “16”). Local model packager 115 repeats the process of generating hexadecimal strings for each row. Resulting in an encoded matrix in hexadecimal format of “160202010100”. One of ordinary skill in the art will appreciate that the other formats of the encoded matrix exist without deviating from the invention. For example, the matrix's binary values are used to represent the matrix. As another example, other known encoding scheme (such as ASCII) and/or any known numbering system (such as octal) are used to represent the values of the matrix.

In this example, local model data 113 represents example business process model 340 in XML as the nodes or components are modeled, as discussed above. An example Table 6 of an XML model for the relationships of example business process model 340 is given below:

```
TABLE 6
<edgeContents
  xsi:type=″com.btools.bom.model.processes.activities:ControlFlow“
  target=″BLM-1234567890123456789002″ source=″BLM-
  1234567890123456789001“/>
<edgeContents
  xsi:type=″com.btools.bom.model.processes.activities:ControlFlow″
  target=″BLM-1234567890123456789003” source=″BLM-
  1234567890123456789001“/>
<edgeContents
  xsi:type=″com.btools.bom.model.processes.activities:ControlFlow″
  target=″BLM-1234567890123456789004” source=″BLM-
  1234567890123456789001“/>
<edgeContents
  xsi:type=″com.btools.bom.model.processes.activities:ControlFlow″
  target=″BLM-1234567890123456789005” source=″BLM-
  1234567890123456789002“/>
<edgeContents
  xsi:type=″com.btools.bom.model.processes.activities:ControlFlow″
  target=″BLM-1234567890123456789005” source=″BLM-
  1234567890123456789003“/>
<edgeContents
  xsi:type=″com.btools.bom.model.processes.activities:ControlFlow″
  target=″BLM-1234567890123456789006” source=″BLM-
  1234567890123456789005“/>
<edgeContents
  xsi:type=″com.btools.bom.model.processes.activities:ControlFlow″
  target=″BLM-1234567890123456789004” source=″BLM-
  1234567890123456789005“/>
```

The example XML code in Table 6 contains an entry for each of the seven workflow paths 351-357 of example business process 340 in FIG. 3B. The workflow proceeds from a source task to a target task. In some embodiments, local model packager 115 generates a packaged version of the model. The packaged model includes a list of enumerated list of the task identifiers of the XML model in addition to a representation of the relationship matrix. Table 7 illustrates an example packaged model of the XML model of Table 6 using example business process model 340:

TABLE 7

1:BLM-1234567890123456789001;
2:BLM-1234567890123456789002;
3:BLM-1234567890123456789003;
4:BLM-1234567890123456789004;
5:BLM-1234567890123456789005;
6:BLM-1234567890123456789006;
M: 160202010100

In the above Table 7, local model packager 115 generates an enumerated list of the tasks and the respective descriptors used when generating the relationship matrix. In addition, local model packager 115 generates an encoded hexadecimal string of the binary values of the relationship matrix and appends the encoded string to the end of the packaged model. The XML model of workflow, Table 6, comprises 1,043 characters. The packaged model, Table 7, comprises 188 characters, resulting in a smaller model.

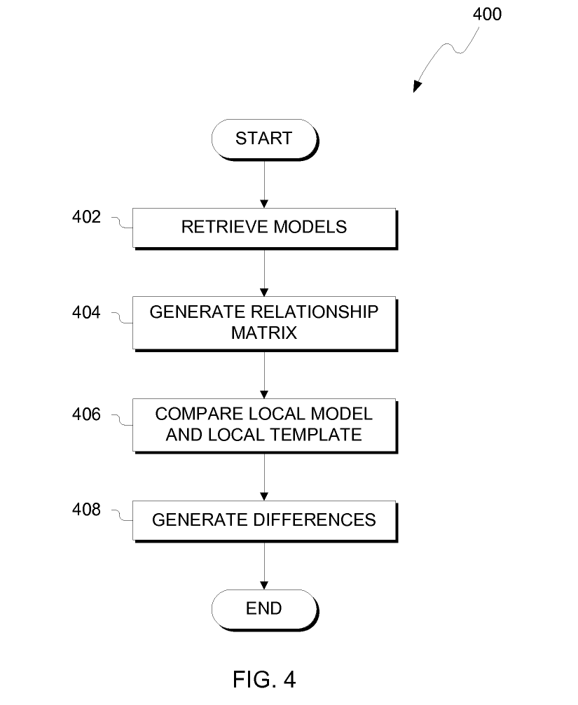

FIG. 4 illustrates operational processes, 400, of packaging a business process model, on a computing device within the environment of FIG. 1, in accordance with an exemplary embodiment of the present invention.

In process 402, local model packager 115 and master model packager 125 retrieve projects, processes or tasks stored in local model data 113 and master model data 123, respectively. In certain embodiments, local model packager 115 and master model packager 125 retrieve local model data 113 and master model data 123, respectively, following the hierarchical structure of projects, then any component processes of the projects and any component tasks of the processes. In other embodiments, local model packager 115 and master model packager 125 retrieve components local model data 113 and master model data 123, respectively, based on a request to synchronize specific components of model data stored in local model data 113 and master model data 123.

In process 404, local model packager 115 and master model packager 125 generates a relationship matrix for projects, processes or tasks stored in local model data 113 and master model data 123, respectively. Each relationship matrix generated by local model packager 115 and master model packager 125, respectively represent the workflow of the projects, processes or tasks stored in local model data 113 and master model data 123. In certain embodiments, the matrix represents the flow of projects, processes or tasks that are prerequisite to subsequent projects, processes or tasks. For example, the rows of the matrix indicate prerequisite projects, processes or tasks. The columns of the matrix represent subsequent projects, processes or tasks to the prerequisite tasks for a given row. The values of the matrix are binary values indicating a true or false state for such conditions.

In process 406, local model packager 115 and master model packager 125 compare projects, processes or tasks stored in local model data 113 and master model data 123, respectively to templates stored in local template data 112 or master template data 122. Templates stored in local template data 112 and master template data 122 contain components of model data with specific details of projects, processes or tasks designated as placeholders for specific project, process or task data. Local model packager 115 and master model packager 125 compare local model data 113 and master model data 123, respectively to determine any information not present or different from the information stored in local template data 112 or master template data 122.

In process 408, local model packager 115 and master model packager 125, respectively generate a differences model based on the comparison performed in process 406. Local model packager 115 and master model packager 125 generate any additional information included in the descriptions of the projects, processes or tasks not present in local template data 112 and master template data 122. Local model packager 115 and master model packager 125 generate any projects, process or tasks to be removed or added based on the presence or absence of the project, process or task in local template data 112 or master template data 122 in comparison to local model data 113 or master template data 123, respectively.

FIG. 5 depicts a block diagram, 500, of components of local device 110 and master device 120, respectively, in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Local device 110 and master device 120 include, respectively, communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 514 and cache memory 516. In general, memory 506 can include any suitable volatile or non-volatile computer-readable storage media.

Local template data 112, local model data 113, local model packager 115, model comparator 116, local model updater 117, master template data 122, master model data 123, master model packager 125 and master model updater 127 are stored in persistent storage 508 for execution and/or access by one or more of the respective computer processors 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 510, in these examples, provides for communications with other data processing systems or devices, including resources of network 130. In these examples, communications unit 510 includes one or more network interface cards. Communications unit 510 may provide communications through the use of either or both physical and wireless communications links. Local template data 112, local model data 113, local model packager 115, model comparator 116, local model updater 117, master template data 122, master model data 123, master model packager 125 and master model updater 127 may, respectively, be downloaded to persistent storage 508 through communications unit 510.

I/O interface(s) 512 allows for input and output of data with other devices that may be connected to local device 110 and master device 120. For example, I/O interface 512 may provide a connection to external devices 518 such as a keyboard, keypad, a touch screen, and/or some other suitable input device. External devices 518 can also include portable computer-readable storage media such as, for example, thumb drives, portable optical or magnetic disks, and memory cards. Software and data used to practice embodiments of the present invention, e.g., Local template data 112, local model data 113, local model packager 115, model comparator 116, local model updater 117, master template data 122, master model data 123, master model packager 125 and master model updater 127, can be respectively stored on such portable computer-readable storage media and can be loaded onto persistent storage 508 via I/O interface(s) 512. I/O interface(s) 512 also connect to a display 520.

Display 520 provides a mechanism to display data to a user and may be, for example, a computer monitor, or a television screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be noted that the term(s) “Smalltalk” and the like may be subject to trademark rights in various jurisdictions throughout the world and are used here only in reference to the products or services properly denominated by the marks to the extent that such trademark rights can exist.

What is claimed is:

1. A method of packaging a business process model, the method comprising:
determining, by one or more processors, one or more differences between a first business process model and one or more templates;
determining, by the one or more processors, one or more paths of workflow for the first business process model; and
generating, by the one or more processors, a first generated model, wherein the generated model includes, at least in part, the determined one or more differences and the determined one or more paths.

2. The method of claim 1, wherein the first generated model has a smaller amount of information than the first business process model.

3. The method of claim 1, the method further comprising:
receiving, by the one or more processors, a second generated model, wherein the second generated model is based, at least in part, on a second business process model; and
determining, by the one or more processors, one or more differences between the first and second generated models.

4. The method of claim 3, the method further comprising:
updating, by the one or more processors, the first business process model based on, at least in part, the differences between the first and second generated models.

5. The method of claim 1, wherein the one or more templates comprise one or more nodes and the one or more nodes respectively include at least one or more input or output paths.

6. The method of claim 1, the method further comprising:
generating, by the one or more processors, a matrix based, at least in part, on the workflow of the first business process model, wherein the dimensions of the matrix are based, at least in part, on a amount of components of the first business process model.

7. The method of claim 6, the method further comprising:
determining, by the one or more processors, a first component of the first business model to be an input to a second business component; and
generating, by the one or more processors, a value for an element of the matrix based, at least in part, on the determined input of the first component.

8. A computer program product for packaging a business process model, the computer program product comprising:
one or more computer-readable storage media and program instructions stored on the one or more computer-readable storage media, the program instructions comprising:
program instructions to determine one or more differences between a first business process model and one or more templates;
program instructions to determine one or more paths of workflow for the first business process model; and
program instructions to generate a first generated model, wherein the generated model includes, at least in part, the determined one or more differences and the determined one or more paths.

9. The computer program product of claim 8, wherein the first generated model has a smaller amount of information than the first business process model.

10. The computer program product of claim 8, the program instructions further comprising:
program instructions to receive a second generated model, wherein the second generated model is based, at least in part, on a second business process model; and
program instructions to determine one or more differences between the first and second generated models.

11. The computer program product of claim 10, the program instructions further comprising:
program instructions to update the first business process model based on, at least in part, the differences between the first and second generated models.

12. The computer program product of claim 8, wherein the one or more templates comprise one or more nodes and the one or more nodes respectively include at least one or more input or output paths.

13. The computer program product of claim 8, the program instructions further comprising:
program instructions to generate a matrix based, at least in part, on the workflow of the first business process model, wherein the dimensions of the matrix are based, at least in part, on a amount of components of the first business process model.

14. The computer program product of claim 13, the program instructions further comprising:
program instructions to determine a first component of the first business model to be an input to a second business component; and
program instructions to generate a value for an element of the matrix based, at least in part, on the determined input of the first component.

15. A computer system for packaging a business process model, the computer system comprising:
one or more computer processors;
one or more computer readable storage media; and
program instructions stored on the computer readable storage media for execution by at least one of the one or more processors, the program instructions comprising:
program instructions to determine one or more differences between a first business process model and one or more templates;
program instructions to determine one or more paths of workflow for the first business process model; and
program instructions to generate a first generated model, wherein the generated model includes, at least in part, the determined one or more differences and the determined one or more paths.

16. The computer system of claim 15, wherein the first generated model has a smaller amount of information than the first business process model.

17. The computer system of claim 15, the program instructions further comprising:
program instructions to receive a second generated model, wherein the second generated model is based, at least in part, on a second business process model; and
program instructions to determine one or more differences between the first and second generated models.

18. The computer system of claim 17, the program instructions further comprising:
program instructions to update the first business process model based on, at least in part, the differences between the first and second generated models.

19. The computer system of claim 15, wherein the one or more templates comprise one or more nodes and wherein the one or more nodes respectively include one or more input or output paths.

20. The computer system of claim 15, the program instructions further comprising:
program instructions to generate a matrix based, at least in part, on the workflow of the first business process model, wherein the dimensions of the matrix are based, at least in part, on a amount of components of the first business process model.
